(19) United States
(12) Patent Application Publication
(10) Pub. No.: US 2014/0161557 A1
(43) Pub. Date: Jun. 12, 2014

(54) SECURITY SEAL WITH ANTI-TAMPERING CONSTRUCTION FEATURE

(71) Applicants: OREBES FERNANDES, Sao Paul (BR); TAKASHI ASSANO, Sao Paul (BR)

(72) Inventors: OREBES FERNANDES, Sao Paul (BR); TAKASHI ASSANO, Sao Paul (BR)

(21) Appl. No.: 14/103,787

(22) Filed: Dec. 11, 2013

(30) Foreign Application Priority Data
Dec. 12, 2012 (BR) BR 20 2012 031675

(51) Int. Cl. G09F 3/03

(52) U.S. Cl. CPC G09F 3/0317
USPC 411/337

(57) ABSTRACT

AN ANTI-TAMPERING SECURITY SEAL HAVING A CONSTRUCTION FEATURE having strap or prolonged tail, with striated texture, followed by teeth arranged in a double or single row, attached to base platform, wherefrom cylindrical pin is centrally or perpendicularly raised surmounted by nozzle-shaped head, for permanent insertion and fitting into central hole for locking larger receptacle or bushing, connected or not by connecting rod to said base platform, wherefrom cylindrical pin is centrally or perpendicularly raised surmounted by nozzle-shaped head, for permanent insertion and fitting into central hole for locking of larger receptacle or bushing, connected or not by connecting rod to said base platform. Adjacent to larger receptacle or bushing is smaller receptacle, with hollow opening, and such seal can include a device for transmitting data, indicating presence, location, etc., which can be made through an electronic chip, radiofrequency sensor or similar device, placed in any part of it.

### CROSS-REFERENCE TO RELATED APPLICATION

This application claims the benefit of Brazilian Patent application no. BR 20 2012 031675-2 filed on Dec. 12, 2012 with the Brazilian Patent Office, INPI, in the name of PLÁSTICOS POLYVIG LTDA.

### FEDERALLY SPONSORED RESEARCH

Not Applicable

### SEQUENCE LISTING OR PROGRAM

Not Applicable

### BACKGROUND

The current invention relates to a security seal having an anti-tampering construction feature designed to seal and prevent tampering of objects and/or places where a “pin-and-bushing” type security seal is used.

Said security seal having said construction feature was conceived, designed, and developed in order to perfect, and bring together, a number of improvements and advantages over conventional security seals existing in the marketplace. Relevant practical and functional solutions were added, in addition to improving safety and use, while allowing more versatility.

More precisely, said security seal with the construction feature stands out from other models existing in the marketplace and the state of art because it adds a second seal into a single device, the “pin-and-bushing” type security seal (“first seal”), to improve security and to evidence any tampering with the first seal. This greatly increases security by preventing both the tampering of the first seal and the attempt to restore and mask tampering of the first seal.

Furthermore, such security seal may or not include a device for transmitting data in the form of an electronic strip, radio frequency sensor, or similar device, for indicating the presence or location of the seal.

Some forms of tampering with the pin-and-bushing type security seal are known. Equipment can be used to damage the locking system, involving high impact or high rotation of the bushing, which opens the seal. Thus, unscrupulous people, after being successful in their criminal intents, close the already damaged security seal using glues, or otherwise fix parts of the pin and bushing security seal whose tampering goes unnoticed.

Therefore, and in order to properly solve such problem, the inventor, a person engaged in the same field, after identifying, studying and testing new plausible alternatives, conceived, designed and developed a security seal with a construction feature, where a second seal is applied to evidence such tampering. Thus, it is impossible to tamper the “pin-and-bushing” seal without damaging the second seal tail, which, when broken, evidences tampering with the “pin-and-bushing” seal.

### SUMMARY

Security seal with anti-tampering construction feature consisting of a double seal, bringing essentially a larger receptacle, or a bushing to receive a fitting pin, adjacent to the smaller receptacle through which a strap with toothed sections passes at the time the device is set.

In its constructional aspect, the security seal in question defines a strap or prolonged tail, of striated texture, followed by a number of teeth in a double or single row, attached to a quadrangular base platform (or to any other geometrical shape) wherefrom a cylindrical pin is raised centrally and perpendicularly, surmounted by a nozzle-shaped head for permanent insertion and fitting to the central hole for locking of the larger receptacle or bushing, connected or not by the connecting rod to the base platform.

There is, adjacent to the larger receptacle or bushing, a smaller receptacle, with a hollow opening, through which a strap or tail is passed, locking and preventing the teeth from returning to the inner obstacle (not shown), after setting the assembly.

### DRAWINGS

FIG. 1 shows a perspective view of the security seal in question;

FIG. 2 shows a side view of the security seal;

FIG. 3 shows it from a top view;

FIG. 4 illustrates said seal in set position, and

FIG. 5 brings a variant of the seal model, which can also have ball-shaped receptacles, pulleys, steel claws, plastic latches, etc., as well as variations in relation to the straps (toothed, flat without teeth, steel cable, wire rope, etc.).

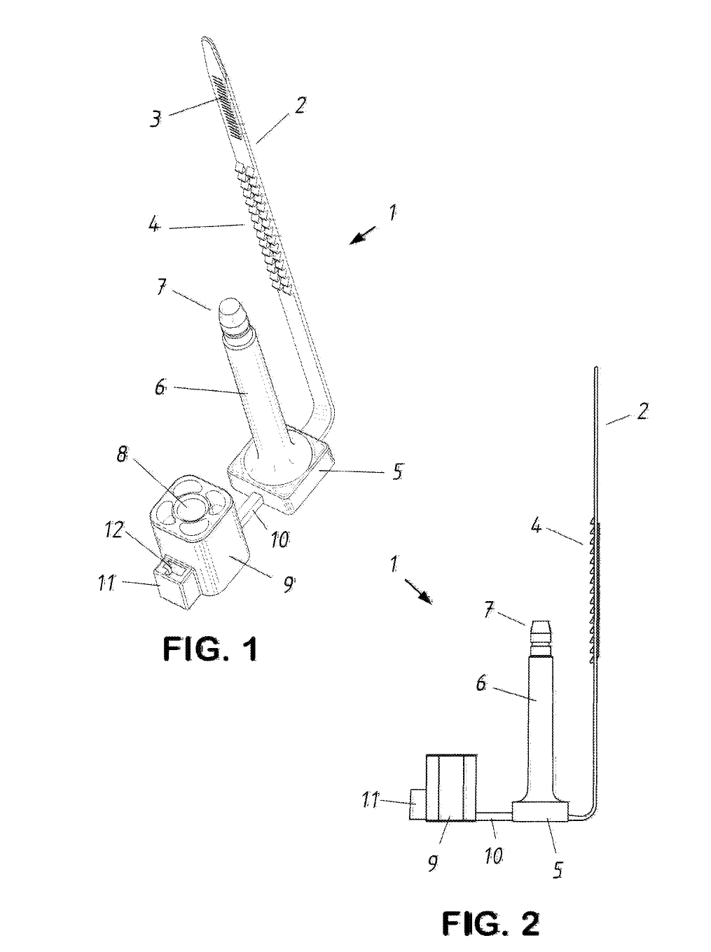

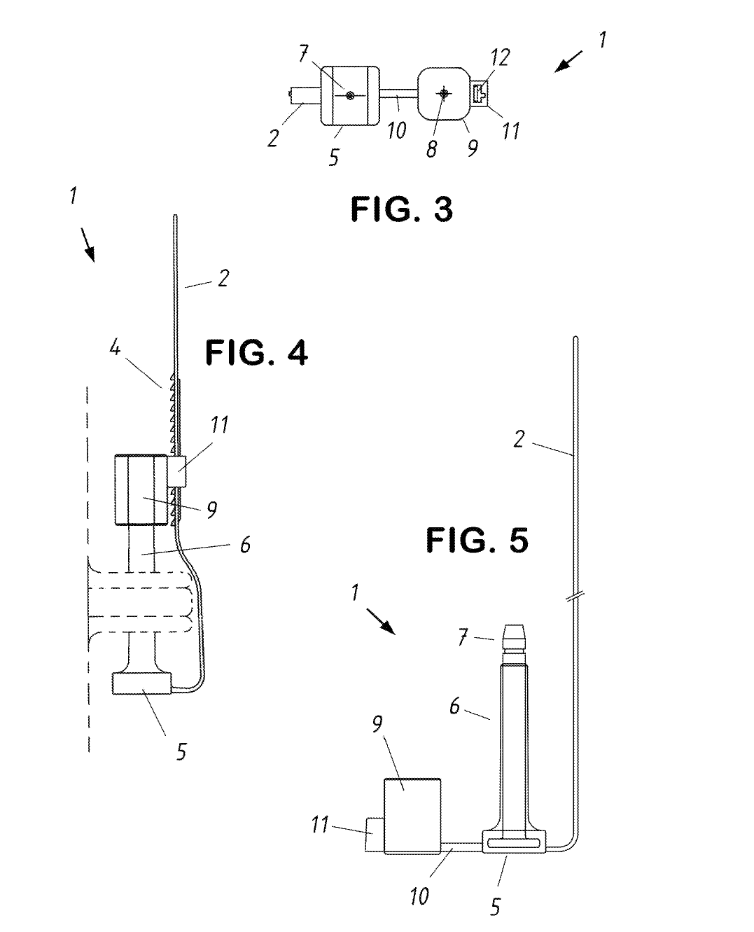

### DESCRIPTION

Based on such illustrations and in accordance with the description presented herein, this application for a patentable improvement refers to a security seal with a construction feature, pertaining to the area of articles designed to seal and prevent tampering, said seal (1) defines a strap or prolonged tail (2), with a striated texture (3), followed by a number of teeth in double or single row (4), attached to a base platform (5), wherefrom a cylindrical pin is centrally or perpendicularly raised (6) surmounted by a nozzle-shaped head (7), for permanent insertion and fitting into the central hole of locking (8) of the larger receptacle or bushing (9), connected or not by a connecting rod (10) to said base platform (5).

Adjacent to the larger receptacle or bushing (9), there is a smaller receptacle (11), with a hollow opening (12), where the strap or tail passes through (2), locking and preventing the teeth from returning to the inner obstacle (not shown), after setting the assembly. Such seal can also include a device for transmitting data, indicating presence, location, etc., which can be in the form of an electronic chip, radio frequency sensor or similar device, placed in any part of it.

In view of what has been disclosed and shown, the security seal with the construction feature brings significant advantages in relation to what it is intended, conforming perfectly to the criteria, which defines patentable improvement, i.e., it delivers the combination and modification of elements already known, adding a new way or detail, resulting in functional improvement in its use or manufacture. It should be emphasized that the preferred embodiment of this model has been described, so any changes in materials, sizes and/or modifications relating thereto, are to be understood and being within the scope as presented herein.

What is claimed:

1. A SECURITY SEAL HAVING AN ANTI-TAMPERING CONSTRUCTION FEATURE, pertaining to an area of articles designed to seal and prevent tampering, wherein said seal (1) defines a strap or prolonged tail (2), with striated texture (3), followed by a number of teeth in double or single row (4), attached to a base platform (5), wherefrom a cylindrical pin is centrally or perpendicularly raised (6) surmounted by a nozzle-shaped head (7), for permanent insertion and fitting into the central hole of locking (8) of the larger receptacle or bushing (9), connected or not by a connecting rod (10) to said base platform (5), and adjacent to the larger receptacle or bushing (9), there is a smaller receptacle (11), with a hollow opening (12), and such seal can also include or not, a device for transmitting data, indicating presence or location, which can be in the form of an electronic chip, radio frequency sensor or similar device, placed in any part of said seal.
